(19) United States
(12) Patent Application Publication
(10) Pub. No.: US 2015/0348391 A1
(43) Pub. Date: Dec. 3, 2015

(54) TWO PART DIGITAL INTELLIGENCE UNIT FOR GAS CYLINDERS

(71) Applicant: Derrick Ernest Hilton, Cobham (GB)

(72) Inventor: Derrick Ernest Hilton, Cobham (GB)

(21) Appl. No.: 14/711,814

(22) Filed: May 14, 2015

Related U.S. Application Data
(60) Provisional application No. 62/004,916, filed on May 30, 2014.

(51) Int. Cl. G08B 21/18

(52) U.S. Cl. CPC G08B 21/18

(57) ABSTRACT

A Digital intelligence Unit (CIU) for use with gas cylinders is provided with two distinct parts, a Base Intelligence Unit (BIU) that provides basic functionality and a Customer Intelligence Unit (CIU) that provides greater processing functionality and that may be customized to meet individual user needs.

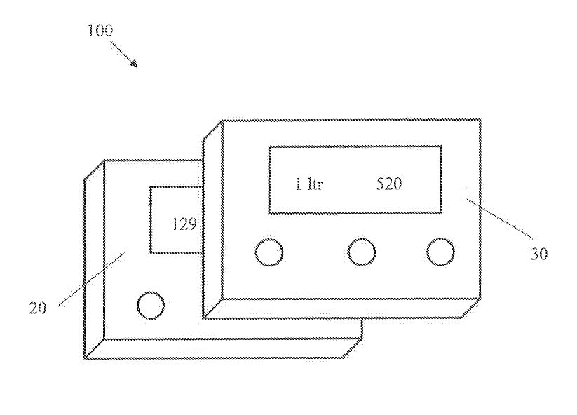

### FIELD OF THE INVENTION

The present invention relates to monitoring of gas cylinder conditions using a Digital Intelligence Unit (DIU) and to DIUs having increased functionality.

### BACKGROUND OF THE INVENTION

Gas cylinders are used in a great many commercial, industrial and laboratory settings to supply a wide variety of gases for a great many different processes and functions. Gas cylinders provide an efficient and reliably way to transport and store gases. In order to provide a sufficient amount of gas, the desired gas is stored under pressure as high as 2,500 psi in the cylinder. Because of these high pressures as well as other safety concerns and to provide greater functionality of the gas cylinder, it is important to monitor certain conditions of the stored gas. The most common condition that is monitored is the pressure remaining in the cylinder that can be used to calculate the approximate amount of gas left in the cylinder. However, different gas users may need different types of information about the cylinder conditions. For example, the amount of gas remaining in the cylinder may be important for welding gas users, whereas the actual pressure of the gas in the cylinder may be important for laboratory user.

A Digital intelligence Unit (DIU) is often associated with the cylinder to provide a read out of the condition of the cylinder. This DIU is generally as small electronic box affixed to the outside of the cylinder or the valve head of the cylinder. Current DIUs remain connected to the cylinder and have a predetermined, fixed functionality. As noted, because different users may have different needs, the fixed functionality of the DIU may be useful to some users by not to others. Upgrading existing DIUs on cylinders to provide a wider range of functionality is not feasible as it would be very costly. Further, segregating cylinders and providing different types of DIUs for different users is not feasible, again because of cost and inventory control issues.

There remains a need in the art for improvements to DIUs for gas cylinders.

### SUMMARY OF THE PRESENT INVENTION

The present invention provides an improved DIU for use with gas cylinders. The DIU of the invention provides greater functionality and versatility than existing DIUs by spitting the DIU into two distinct parts, a Base Intelligence Unit (BIU) that provides basic functionality and a Customer Intelligence Unit (CIU) that allows for customization to meet individual user needs.

### BRIEF DESCRIPTION OF THE DRAWINGS

The FIGURE is a schematic view of the Digital Intelligence Unit according to the invention.

### DETAILED DESCRIPTION OF THE INVENTION

The present invention provides a DIU for use with gas cylinders wherein the DIU is provided as a two part system, the first part being a Base Intelligence Unit (BIU) that provides basic functionality and is associated directly with the cylinder and the second part being a Customer Intelligence Unit (CIU) that may be customization to meet individual user needs and that may be carried by the user.

The present invention will be described in greater detail with reference to the drawing FIGURE. In particular, the drawing FIGURE shows a DIU system 100 of the invention made of two parts, the first part being the BIU 20 and the second part being the CIU 30. The BIU 20 is fitted to the cylinder or to the valve guard for the cylinder in a manner that may be permanent or semi-permanent. The BIU 20 contains minimal interactive capability with a user and possesses only simple functionality. For example, the BIU 20 is capable of receiving and processing a signal from a sensor that cooperates with the cylinder, such as a pressure sensor or temperature sensor mounted to the valve, cylinder body or regulator used with the cylinder. The BIU 20 may display the received information as a number, percentage or an icon. Alternatively, the BIU 20 may have no display at all.

The CIU 30 is designed to fit onto the BIU 20 for storage and delivery purposes and the CIU 30 interacts directly with the BIU 20. However, the CIU 30 is also detachable and may be kept remotely from the cylinder or carried by the user. The CIU 30 contains a higher level of processing capability and may be customized to provide specific information to the user. The CIU 30 and BIU 20 communicate with each other by any standard method, including wireless telecom, RFID or high speed optical communications. In addition, the CIU 30 can be provided with additional functionality such as UPS or wireless telephony service.

As noted, the BIU contains only simply processing capability. For example, if a pressure monitor is associated with the cylinder, the BIU receives the pressure signal and can process that signal to determine the percentage content of gas remaining in the cylinder. This percentage can be displayed by the BIU if a display is present. The CIU includes greater processing capability. The CIU will receive the pressure reading from the BIU and then the CIU can process that information to provide a variety of information to the user. For example, the CIU can display an approximation of how much longer the cylinder will last given current conditions. The CIU can also be updated and configured to provide specific information requested by the customer. No change would be necessary to the BIU making such an upgrade much easier and cost effective.

Other examples of information that the CIU can provide to the user include, sending an alarm in the event the pressure of the cylinder falls below a predetermined reading, and setting the reading for conditions specific to a particular use such as welding or laboratory process. The CIU can be used to interface with a single BIU or with multiple BIUs and therefore can be used in monitoring small or large operations. In addition, the CIU can contain additional functionality such as Bluetooth, or GPS. This increases the versatility of the system. For example, if a fuel cell interacts with a cylinder, the CIU could be equipped to signal a back-up fuel cell to start up upon certain conditions being relayed from the BIU associated with the cylinder for the main fuel cell to the CIU. Also, many cylinders are used in remote locations where checking the DIU or the BIU can be arduous. With the system of the invention, the CIU can receive information from the remote location making monitoring much easier, less time consuming and less expensive. In addition, many cylinders are used in large warehouse settings where having a CIU equipped with GPS could make finding a particular cylinder for change over or another purpose, much easier and quicker.

It is anticipated that other embodiments and variations of the present invention will become readily apparent to the skilled artisan in the light of the foregoing description, and it is intended that such embodiments and variations likewise be included within the scope of the invention as set out in the appended claims.

What is claimed:

1. A digital intelligence unit for use with a gas cylinder comprising:
a base intelligence unit; and
a customer intelligence unit detachable connected to the base intelligence unit.

2. The digital intelligence unit according to claim 1 wherein the base intelligence unit is permanently or semi-permanently attached to the gas cylinder.

3. The digital intelligence unit according to claim 1 wherein the base intelligence unit provides basic functionality pressure or temperature reading for the gas cylinder.

4. The digital intelligence unit according to claim 1 wherein the base intelligence unit includes a display.

5. The digital intelligence unit according to claim 1 wherein the base intelligence unit and customer intelligence unit communicate with each other using wireless telecom, RFID or high speed optical communications.

6. The digital intelligence unit according to claim 1 wherein the customer intelligence unit provides customizable functionality, such as GPS or wireless telephony service.

7. The digital intelligence unit according to claim 1 wherein the customer intelligence unit sends an alarm to a user based on predetermined settings.

8. A method of monitoring conditions of a gas cylinder using a digital intelligence unit comprising a base intelligence unit and a customer intelligence unit detachable connected to the base intelligence unit.
